(19) United States
(12) Patent Application Publication
(10) Pub. No.: US 2021/0262257 A1
(43) Pub. Date: Aug. 26, 2021

(54) SMART HATCH ACTUATION AND LOCKING SYSTEMS FOR HATCHES WINDOWS AND DOORS

(71) Applicants: James Stranger, Chino, CA (US); Brittany Stone, Chino, CA (US)

(72) Inventors: James Stranger, Chino, CA (US); Brittany Stone, Chino, CA (US)

(21) Appl. No.: 17/181,980

(22) Filed: Feb. 22, 2021

Related U.S. Application Data
(60) Provisional application No. 63/030,294, filed on May 26, 2020.
(60) Provisional application No. 63/026,715, filed on May 18, 2020.
(60) Provisional application No. 62/979,124, filed on Feb. 20, 2020.

(51) Int. Cl. E05C 3/08; E05C 3/00; E05F 1/00

(52) U.S. Cl. CPC E05C 3/08; E05C 9/08; E05F 1/00; E05C 3/008

(57) ABSTRACT

The inventive subject matter of this application is directed to system and methods that bring about the opening and closing of hatches, doors, windows, or other hinged openings. Embodiments of the inventive subject matter feature one or more levers that are coupled with a motor or linear actuator. Upon activating a motor or linear actuator, a lever coupled thereto (e.g., by a linkage) rotates, taking the system from a locked configuration to an unlocked configurations. In some embodiments, continued actuation brings the system from a closed configuration to an open configuration.

This application claims priority to U.S. Provisional Patent Application No. 63/030,294 filed May 26, 2020; U.S. Provisional Patent Application No. 63/026,715 filed May 18, 2020; and U.S. Provisional Patent Application No. 62/979,124 filed Feb. 20, 2020. All extrinsic materials identified in this application are incorporated by reference in their entirety.

### FIELD OF THE INVENTION

The field of the invention is opening/closing systems and locking/unlocking systems for hatches, doors, windows, and other hinge-based openings.

### BACKGROUND

The background description includes information that may be useful in understanding the present invention. It is not an admission that any of the information provided in this application is prior art or relevant to the presently claimed invention, or that any publication specifically or implicitly referenced is prior art.

Boats, buildings, ships, watercraft, cars, cruise ships, RVs, mobile homes, buses, aircraft, vans, structures, animal enclosures and all other manner of vehicles and vessels that have an interior space often incorporate hatches or doors that can open an interior space out to the exterior. For example, a boat's cabin can include one or more hatches to, among other things, facilitate airflow and to allow for ingress and egress. Until now, these components have gone largely unchanged, despite many advancements in technology that have brought about smaller, more powerful actuators that require less energy to use, as well as better electronics to facilitate control systems and to allow for wireless communication and control.

One example of an effort to improve on existing boat hatches is U.S. Pat. No. 8,688,329 to Cathcart. This patent is directed to a hatch having a linear actuator that can be used to open and close the hatch. But the Cathcart patent fails to contemplate many different improvements that can be implemented using newer technologies described in this application.

Examples of improved watercraft hatches are few and far between, but even innovations in other fields, such as car doors, indicate there is ample room for improvement. European Patent Application No. 1087080 is directed to car door systems as opposed to marine door systems. But even this application fails to consider new mechanisms and systems described in this application that can be implemented to cause a door to swing open, and it similarly fails to consider using a variety of different sensors to automate opening and closing of the door.

Thus, there still exists a need in the art for improved hatches for various uses e.g., in watercraft, vehicles, structures, and other applications.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

### SUMMARY OF THE INVENTION

The present invention provides apparatuses, systems, and methods directed to locking/unlocking and opening/closing systems that can be implemented with hinged opening covers (e.g., lids, hatches on boats, doors in doorways, windows on buildings, etc.).

In one aspect of the inventive subject matter, a locking, unlocking, opening, and closing system for hinged opening covers is contemplated, the system comprising: a linear actuator; a linear actuator arm coupled to the linear actuator; an anchor configured to couple to a lid; a lever rotatably coupled with the anchor; and where the linear actuator arm is rotatably coupled with an end of the lever.

In some embodiments, the linear actuator is coupled with a linear actuator pivot that is configured to couple with a base. The anchor is configured to couple with the lid on a side of the lid opposite the linear actuator pivot. In some embodiments, the cam action coupling comprises a pin joint, and in some embodiments the lever is rotatably coupled with the anchor by a pin joint.

In some embodiments, the system additionally includes: a second linear actuator; a second linear actuator arm coupled to the second linear actuator; a second anchor configured to couple to the lid; a second lever rotatably coupled with the second anchor; and the second linear actuator arm rotatably coupled with an end of the lever by a pin joint. In some embodiments, the lever comprises a bend and the pin joint coupling is positioned between the end of the lever and a second end of the lever. The lid can couple with the base by a hinge, and the linear actuator pivot point is offset from the hinge. In some embodiments, the linear actuator pivot point is offset from the hinge on an interior side of the lid.

In some embodiments, extending the linear actuator unlocks the lid and retracting the linear actuator locks the lid. In some embodiments, extending the linear actuator past unlocking the lid can cause the lid to open. In some embodiments, the linear actuator arm is coupled with an end of the lever by a cam action coupling.

A locking and unlocking system for hinged opening covers is contemplated in another aspect of the inventive subject matter. The system comprises: an anchor configured to couple to a lid; a linear actuator rotatably coupled with the anchor where the linear actuator is rotatably coupled with an end of the lever by a pin joint coupling, and where the lever is rotatably coupled with the anchor such that it can rotate upon actuating the linear actuator.

In some embodiments, retracting the linear actuator unlocks the lid and extending the linear actuator locks the lid. In some embodiments, the lever comprises a complementary shape to the base.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a side, cutaway view of a system of the inventive subject matter in a locked configuration.

FIG. 2 is a side cutaway view thereof in an unlocked configuration.

FIG. 3 is a side cutaway view thereof in a partially open configuration.

FIG. 4 shows a bottom view thereof in a locked configuration.

FIG. 5 shows a bottom view thereof in an unlocked configuration.

FIG. 6 shows a bottom view thereof in a partially open configuration

FIG. 7 shows another system of the inventive subject matter in a locked configuration.

FIG. 8 shows a side, cutaway view of an embodiment having a spring-loaded mounting bracket.

FIG. 9 shows a side, cutaway view of another locking mechanism in an unlocked configuration.

FIG. 10 shows a side, cutaway view thereof in a locked configuration.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

The inventive subject matter described in this application is directed to hatches and doors for use with all manner of buildings, structures, equipment, mining facilities, aircraft, vessels, and vehicles, including in marine and seafaring settings. Embodiments of the inventive subject matter can be implemented with hatches and doors of any size. Motors having more or less power can be implemented depending on the size of the hatch to be manipulated, and other components can be made larger or smaller or using different materials depending on material strength requirements.

As mentioned above, embodiments of the inventive subject matter can be incorporated into hatches on boats and other watercraft. Although the examples below can be interpreted as pertaining specifically to boats and other watercraft, the inventors specifically contemplate implementing embodiments into any manner of buildings, structures, equipment, mining facilities, aircraft, vessels, and vehicles that have opening doors or windows that could benefit from automated and electronic control. For example, in the context of a building, skylights in many homes are difficult to reach and would benefit from a system that allows for both remote control and for automated control based on, e.g., environmental conditions and user preferences. As such, in this application, the term “lid” without a modifier preceding it (e.g., “hatch lid”) should be interpreted to refer to a hinged cover of an opening, where that opening can be a door, a window, a hatch, etc.

Embodiments include a motorized opening mechanism, a motorized locking mechanism, and can include a manual override (e.g., for the locking mechanism, the opening/closing mechanism, or both). In some embodiments, a solar and battery backup can be included in case of electrical failure, as well as inputs such as buttons, switches, touch screen(s), or even a wireless module to receive remote signals, e.g., from a phone app or from a set of controls in a location other than where the automation system is implemented. Accordingly, some embodiments include helm controls or other remote inputs. It is contemplated that, e.g., helm controls can be incorporated into existing controls at the helm of a vessel (e.g., via a wired, WiFi, Bluetooth or other type of connection) to tie into an existing control systems (e.g., NMEA 2000 or those made by Raymarine, Foruno, etc.). In some embodiments, separate controls can be added to a helm (e.g., a separate touch screen display can be mounted at the helm). It is also contemplated that controls can be mounted in a location other than the helm, or, in some embodiments, remote controls can be placed in multiple locations around a vessel. In contexts outside of watercraft, “helm controls” should be interpreted as being equivalent to remote controls or control panels.

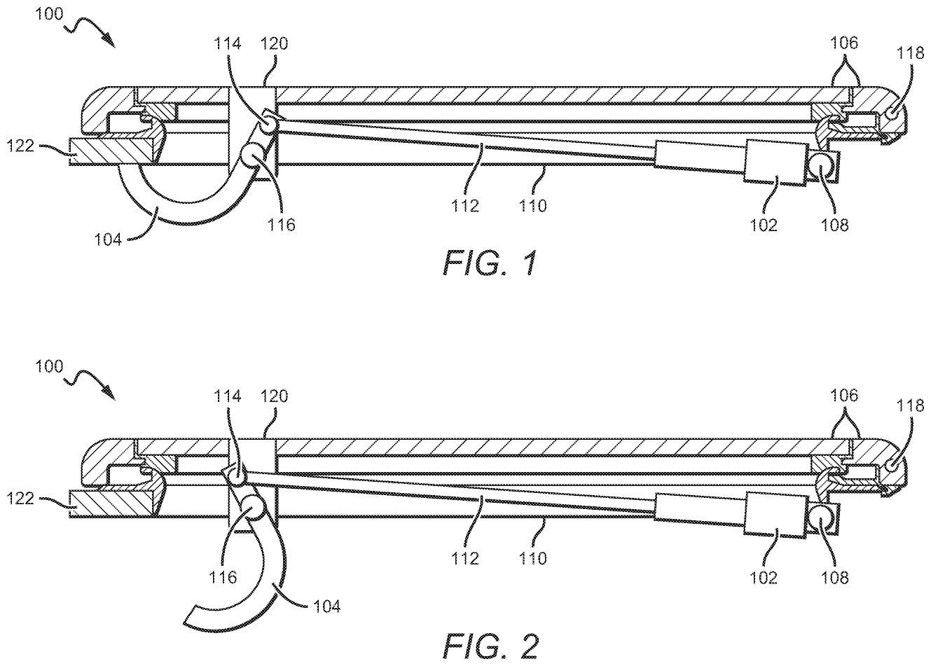

FIGS. 1-4 show a hatch lifting and locking system 100 that implements a linear actuator 102. It is contemplated that multi-stage, multi-linear actuating linear actuators can be implemented in any embodiment described in this application to, e.g., increase the stroke length of actuation. FIG. 1 shows each of the different components of system 100 from a side, cutaway view with the system 100 in a locked configuration. Lever 104 is shown in a position that occurs when linear actuator 102 is retracted. Linear actuator 102 couples with a stationary structural element (e.g., a boat hull, a house wall, a roof). Hatch lid 106 thus moves relative to whatever stationary structural element linear actuator 102 couples with. It is contemplated that linear actuator 102 can couple with any portion of hatch base so long as sufficient leverage exists to lock/unlock and open/close hatch lid. In some embodiments, the stationary structural element is part of system 100 (e.g., coupled with or formed as part of hatch base 110), while in other embodiments the stationary structural element is part of whatever opening the system 100 covers. For example, if a boat has an opening that a hatch can be installed onto, then the linear actuator 102 can couple with the boat's hull. In other applications of the inventive subject matter, the linear actuator would be coupled with a structural element that is stationary relative to the door or other hingedly opening component. Linear actuator 102 is thus coupled to that stationary element on a side of hatch lid 106 that features at least one hinge 118. Hatch lid 106 thus pivots about hinge 118 (additional hinges can also be implemented) when it opens. Linear actuator 102 couples to that stationary element at linear actuator pivot 108.

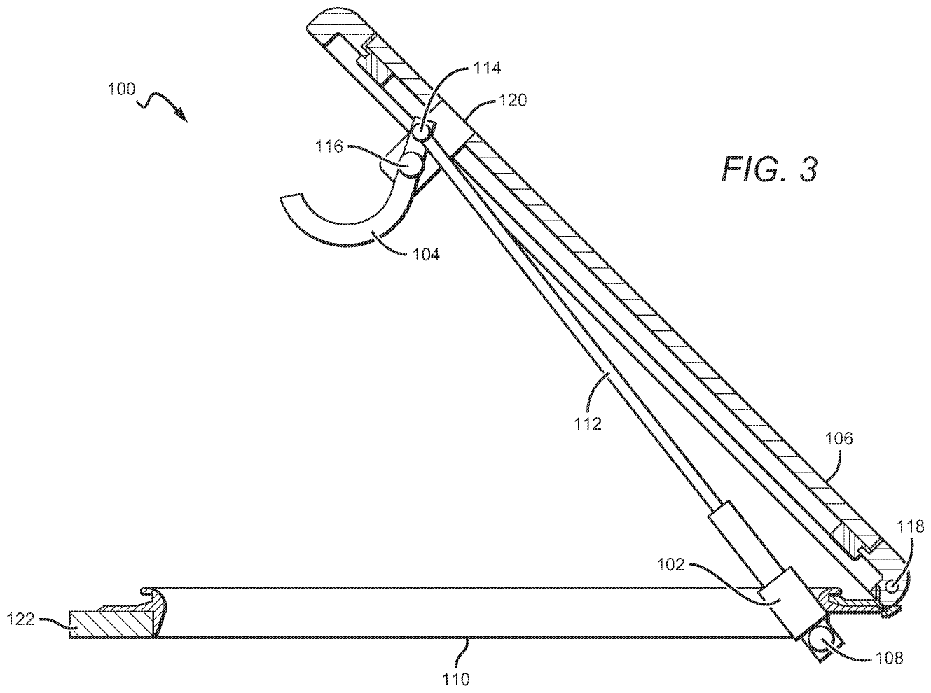

Linear actuator 102 is coupled to a linear actuator arm 112, which connects linear actuator 102 with lever 104 at a coupling point 114 above lever pivot joint 116. When linear actuator 102 extends (e.g., the actuator elongates, pressing outward), it pushes linear actuator arm 112, which in turn presses against lever 104. FIG. 2 shows how lever 104 rotates about pivot joint 116 when linear actuator 102 extends. Because linear actuator arm 112 couples with coupling point 114 (where coupling point 114 is, e.g., a pin joint allowing for one degree of freedom), when linear actuator 102 extends, it causes rotation of lever 104, which releases hatch lid 106 so that it can rotate to an open configuration. As seen in both FIGS. 1 and 2, pivot joint 116 can be coupled to anchor 120, which is itself coupled to hatch lid 106. In some embodiments, anchor is part of hatch lid 106. With lever 104 pivoted into an unlocked configuration, linear actuator 102 can then cause the hatch lid 106 to open by continuing to extend as shown in FIG. 3.

FIG. 3 thus shows a side, cutaway view of system 100 in a partially open configuration. Linear actuator 102 is extended such that lever 104 rotates to an unlocked position and then continues to extend, causing hatch lid 106 to open. Because linear actuator pivot 108 is located below hinge 118, continued extension creates a force vector with a component of that force being applied to hatch lid opening.

Lever 104 can be formed into a variety of different shapes. As shown in FIGS. 1-3, lever 104 is formed into a curved, hook shape. As describe above, linear actuator arm 112 couples with one end of lever 104. The other end of lever 104 is responsible for locking hatch lid 106 down to hatch base 110. To lock, lever 104 braces against bracing element 122. Bracing element 122 can be part of the opening that system 100 covers, or it can be part of system 100 that is then fixed to that opening. Lever 104 is shown in contact with bracing element 122 in FIG. 1.

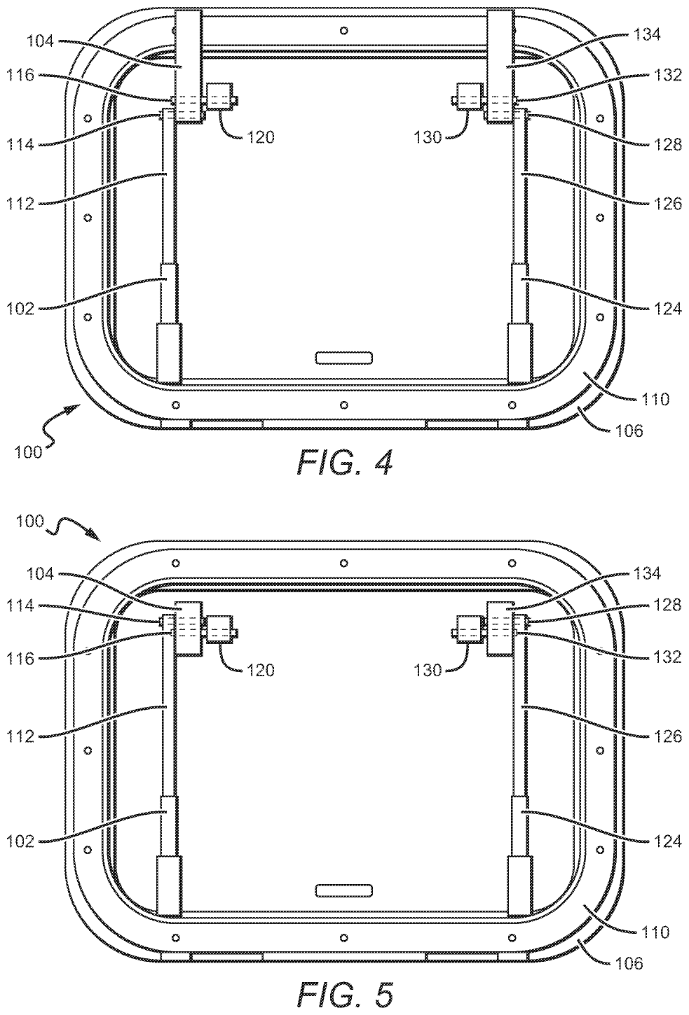

Because FIGS. 1-3 show a side view, only one of the latching, locking, and opening mechanisms of the inventive subject matter can be seen. FIG. 4 shows a bottom view of system 100 in a locked configuration, showing a second set of each component described above. Thus, there is a second linear actuator 124, a second linear actuator arm 126, a second coupling 128, a second anchor 130, a second pivot joint 132, and a second lever 134, each of which correspond to the same components described above. This second set of components can be included to facilitate unlocking and opening of hatch lid. While some embodiments indeed include a single set of components, the second set reduces motor torque or force output requirements, e.g., by half, and introduces some redundancy in case one set of components fails. If one set of components fails, the other set can nevertheless still cause hatch opening, closing, and locking. Using two sets of components also improves the watertight seal at the corners of the hatch.

Thus, as shown in FIG. 4, a first set of components is positioned on the left side of hatch lid 106 while the second set of components is positioned on the right side of hatch lid 106. FIG. 4 shows the system 100 in a locked configuration where levers 104 and 134 are rotated to hold hatch lid 106 closed. From the bottom view, additional details are visible. For example, pivot joint 116 and second pivot joint 132 are both shown as elongated pins. Pivot joint 116 passes through anchor 120 and lever 104, while pivot joint 132 passes through second anchor 130 and second lever 134. Pivot joint 116 and second pivot joint 132 are both single degree of freedom joints.

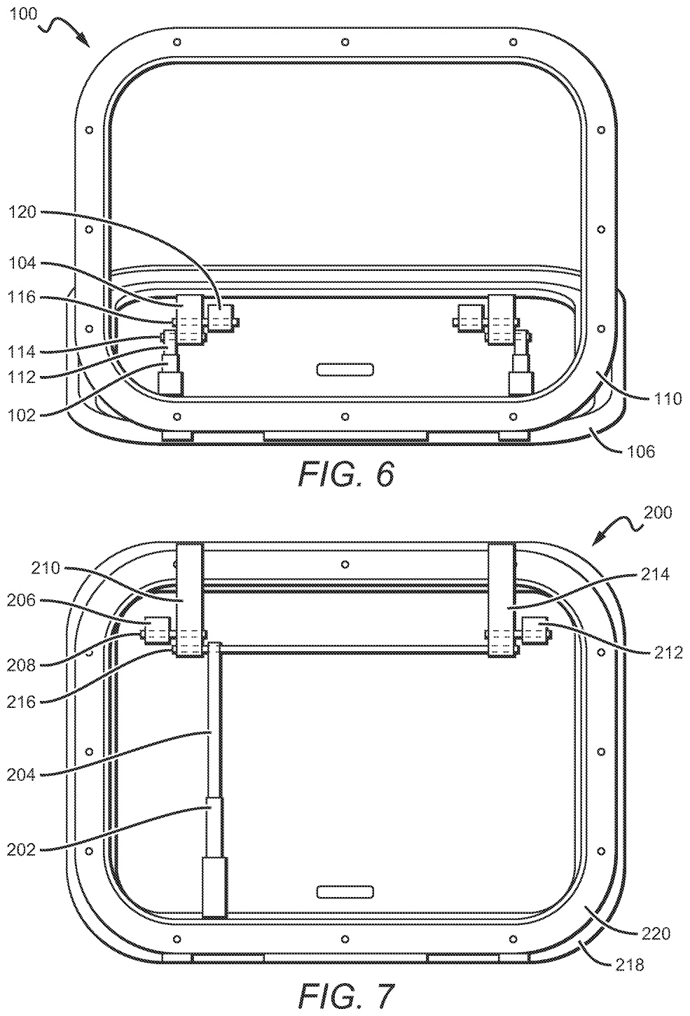

FIG. 5 shows the same view of system 100 as in FIG. 4, except with system 100 in an unlocked configuration. When unlocked, levers 104 and 134 are pulled back such that hatch lid 106 can open without interference by levers 104 and 134. This can be seen as the space between levers 104 and 134 and hatch base 110. Finally, FIG. 6 shows a view looking up from the bottom of hatch base 110 with hatch lid 106 in an open configuration.

FIG. 7 shows system 200, which is an alternative embodiment that includes a linear actuator 202, a linear actuator arm 204, a first anchor 206 and a second anchor 212, a lever pivot joint 208, as well as a first lever 210 and a second lever 214. Because second lever 214 does not have an associated linear actuator, linkage 216 is included to couple movements of levers 210 and 214. Thus, when linear actuator 202 is actuated to extend outward, it causes both levers 210 and 214 to rotate, unlocking hatch lid 218 so that hatch lid 218 can rotate away from hatch base 220 to open.

In some embodiments, coupling 216 can be coupled with lever 210 and second lever 214 such that all three components are fixed relative to one another (e.g., coupling 216 is welded to lever 210 and second lever 214). In such embodiments, linear actuator arm 204 can be rotatably coupled with coupling 216. In some embodiments, linear actuator arm 204 is fixedly coupled with linkage 216, which is in turn rotatably coupled with lever 210 and second lever 214. In still further embodiments, any couplings between linear actuator arm 204, coupling 216, lever 210, and second lever 214 are all rotatable.

Although linear actuator 202 is shown on the left side of hatch lid 218 in FIG. 7, it can be positioned anywhere along the length of coupling 216. In some embodiments, linear actuator 202 can be positioned in the middle of hatch lid 218 so that when it is actuated, it applies a force to the middle of coupling 216, which in turn transfers force to lever 210 and second lever 214. Thus, when linear actuator 202 causes linear actuator arm 204 to extend, it applies force to coupling 216, which in turn causes rotation of lever 210 and second lever 214 to bring system 200 into an unlocked configuration.

In a configuration where linear actuator 202 is positioned in the center of hatch lid 218, forces (and/or moments, depending on configuration) applied to lever 210 and lever 214 by coupling 216 are approximately equal. As with embodiments described above, when linear actuator 202 is actuated, it pulls lever 210 and second lever 214 back to first unlock hatch lid 218 and then to open hatch lid 218.

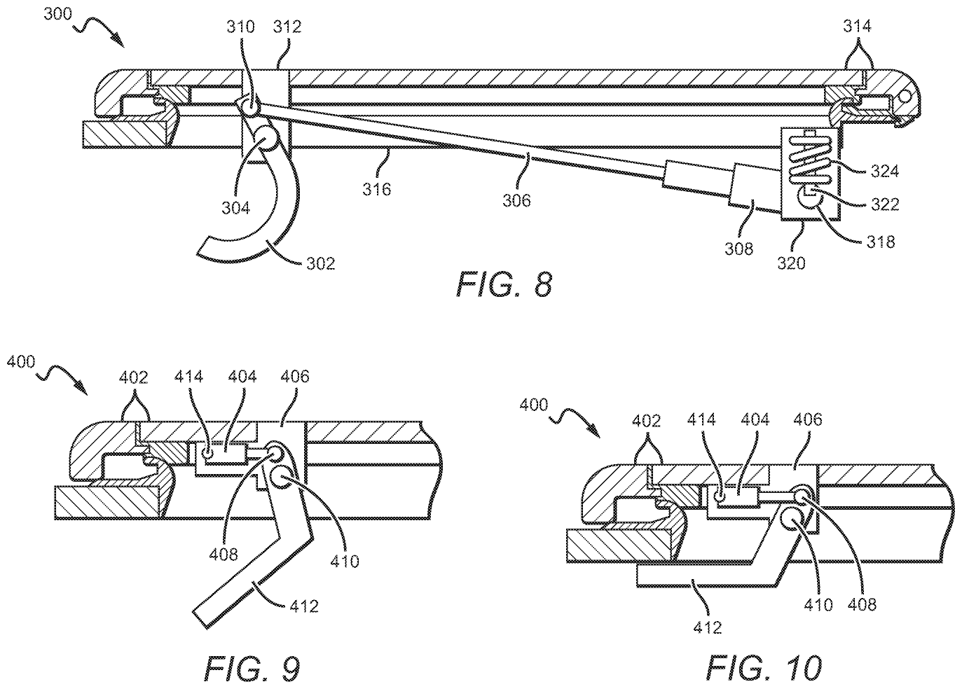

FIG. 8 shows another system 300 of the inventive subject matter. System 300 is configured similarly to embodiments described above regarding FIGS. 1-5. It features a lever 302, a pivot point linkage 304, a linear actuator arm 306, a linear actuator 308, a coupling 310, an anchor to hatch lid 312. As with other embodiments described in this application, anchor to hatch lid 312 is coupled to hatch lid 314 such that upon actuating linear actuator 308, lever 302 unlocks and hatch lid 314 can then be opened by continued actuation of linear actuator 308, which is coupled to hatch base 316 by linear actuator pivot point 318.

A difference between system 300 and systems 100 and 200 is that system 300 additionally includes a spring-loaded mounting bracket 320, a slot 322 within the spring-loaded mounting bracket 320, and a spring 324 also disposed within the spring-loaded mounting bracket 320. Spring 324 and associated components are configured to assist lifting hatch lid 314. Linear actuator pivot 318 is configured to move up and down (as drawn in FIG. 8), guided by slot 322. When linear actuator 308 initially extends (e.g., to change system 300 from a locked configuration to an unlocked configuration by rotating lever 302), tension is released from the system, and force from spring 324 pushes linear actuator 308 downward and away from hatch lid 314. Spring 324 is shown as a coil spring, but it can alternatively be configured as a torsion spring. As long as spring 324 is configured to provide a downward reaction force that causes linear actuator 320 to move away from hatch lid 314 as described above.

In embodiments described in this application, actuators can be disengaged from hatch lids by, e.g., disassembling the pivot points those actuators attach to. For example, in FIG. 8, linear actuator 308 can be disengaged from linear actuator pivot 318. Pivot points can be made using, e.g., rubber nipples, which can facilitate quick release as well as emergency release when too much force is applied. Thus, linear actuator mounts can facilitate quick release of linear actuators, while also helping to prevent damage to the overall system, and using, e.g., rubber nipples allows the system to be disengaged when too much force is applied. Alternatively, linkages can be configured to include a slot and key type assembly, where the linear actuator arm has a button head that can only be installed or removed if the linear actuator's arm is in a particular position relative to the linkage.

In embodiments of the inventive subject matter, a mechanical advantage that facilitates opening and closing hatch lids can be achieved by, e.g., cam action couplings. Cam action couplings can create an additional locking force in their associated levers and act as self-locking mechanisms to prevent hatch lids from being lifted via external force. Lever of the inventive subject matter can take on a variety of shapes depending on specific applications depending on relative distances between anchors, pivot points, and hatch bases.

FIGS. 9 and 10 show a system 400 that is configured for automatic locking and unlocking of hatch lid 402. System 400 includes a linear actuator 404, an anchor 406, a coupling 408, a pivot point 410, and a lever 412. Linear actuator 404 is positioned on the same side of hatch lid as anchor 406, and linear actuator 404 is also positioned on the left side of coupling 408 (it can alternatively be positioned on the right side, in a mirror image configuration). Thus, when linear actuator 404 is actuated to retract, it pulls coupling 408 toward linear actuator 404, which in turn causes lever 412 to move into an unlocked configuration. FIG. 9 shows system 400 in an unlocked configuration. For linear actuator 404 to smoothly pull lever 412 at coupling 408 such that lever 412 can rotate about pivot point 410, linear actuator 404 can be mounted to anchor 406 at rotatable mounting point 414. FIG. 10 shows system 400 in a locked configuration, where lever 412 prevents hatch lid 402 from opening.

Thus, specific systems and methods directed to hatch opening, closing, and locking have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A locking, unlocking, opening, and closing system for hinged opening covers, comprising:
a linear actuator;
a linear actuator arm coupled to the linear actuator;
an anchor configured to couple to a lid;
a lever rotatably coupled with the anchor; and
the linear actuator arm rotatably coupled with an end of the lever

2. The system of claim 1, wherein the linear actuator is coupled with a linear actuator pivot that is configured to couple with a base.

3. The system of claim 2, wherein the anchor is configured to couple with the lid on a side of the lid opposite the linear actuator pivot.

4. The system of claim 1, wherein the coupling comprises a pin joint.

5. The system of claim 1, wherein the linear actuator arm is coupled with an end of the lever by a cam action coupling

6. The system of claim 1, wherein the lever is rotatably coupled with the anchor by a pin joint.

7. The system of claim 1, further comprising:
a second linear actuator;
a second linear actuator arm coupled to the second linear actuator;
a second anchor configured to couple to the lid;
a second lever rotatably coupled with the second anchor; and
the second linear actuator arm rotatably coupled with an end of the lever

8. The system of claim 1, wherein the lever comprises a bend, wherein the cam action coupling is positioned between the end of the lever and a second end of the lever.

9. The system of claim 1, wherein the lid couples with a base by a hinge, and wherein a linear actuator pivot point is offset from the hinge.

10. The system of claim 1, wherein a linear actuator pivot point is offset from the hinge on an interior side of the lid.

11. The system of claim 1, wherein extending the linear actuator unlocks the lid, and wherein retracting the linear actuator locks the lid.

12. The system of claim 1, wherein extending the linear actuator past unlocking the lid causes the lid to open.

13. A locking and unlocking system for hinged opening covers, comprising:
an anchor configured to couple to a lid;
a linear actuator rotatably coupled with the anchor;
the linear actuator rotatably coupled with an end of a lever;
wherein the lever is rotatably coupled with the anchor such that it can rotate upon actuating the linear actuator.

14. The system of claim 13, wherein retracting the linear actuator unlocks the lid and wherein extending the linear actuator locks the lid.

15. The system of claim 13, wherein the lever comprises a bend.
